(19) United States
(12) Patent Application Publication
(10) Pub. No.: US 2006/0081195 A1
(43) Pub. Date: Apr. 20, 2006

(54) Chewing products for domestic carnivorous animals and method for making same

(76) Inventor: Linwang Jiang, Shanghai (CN)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 11/009,107

(22) Filed: Dec. 10, 2004

(30) Foreign Application Priority Data
Oct. 20, 2004 (CN) CN200420107412.7

(51) Int. Cl. A01K 29/00

(52) U.S. Cl. 119/709

(57) ABSTRACT

The present invention provides a chewing product for domestic carnivorous animals. The product comprises rawhide material and natural bone, characterized in that, said natural bone is wrapped up by said rawhide. The present invention perfectly combines the nutrition and delicacy functions of natural bones with dental care function of rawhide chewing product. Meanwhile, the hard exteriors of natural bone provides prolonged chewing time for dogs.

### TECHNICAL FIELD

The present invention relates to chewing products for domestic carnivorous animals. More particularly, the present invention relates to chewing products, primarily for dogs, which are made from rawhide.

### TECHNICAL BACKGROUND

Domestic carnivorous animals, particularly dogs, have a basic instinctive urge to chew. Frequent chewing behavior helps in tooth-strengthening and oral hygiene-maintenance. Therefore, there emerges, as the time requires, the development of the products for chewing by dogs. However, the current products available in the market have drawbacks to different extents.

Prior chewing products, such as rubber toys, nylon toys, latex toys, resin toys or other plastic toys as well as the products made from other synthetic materials, have the property of being able to stand biting and chewing. Namely, they remain unbroken after biting and chewing for long-time. The materials can be processed to form particular shapes to be visually attractive to dogs, but they do not have the odor (both in olfactory sense and in taste sense), which is attractive to dogs. Thus, dogs are not willing to chew these products for long time. Meanwhile, the indigestibility of these materials is one of the major drawbacks.

The later-developed dogs' chewing products, which are made from rawhide, overcome to larger extent the above-mentioned drawbacks. It is because the materials used are solely made from raw animal skin (such as cattle skin and hog skin), which can be completely digested by dogs, and the naturally occurring rawhides are more attractive to dogs. In spite of this major modification, however, the products do not satisfactorily meet dogs' chewing desire in both olfactory and taste senses. A whole rawhide chewing product is often not completely consumed by dogs, leading to certain wasting.

Based on the above rawhide chewing product, attempt of addition of various flavors is made by some manufacturers, so as to enhance the appeal to dogs. This measure improves to certain extent the problems existing in the rawhide chewing product. However, what are added are nothing more than flavoring agents, which fail to provide the true mouth feel or taste. Furthermore, the flavored rawhide chewing product tends to dirty carpet, raising an additional problem.

U.S. Pat. No. 5,673,653 has disclosed a chewing product for dogs which comprises sheets made from rawhide and sheets comprising jerky, said jerky sheets being wrapped in said rawhide sheets. This product solves the above-mentioned problems in a better way. However, jerky may be readily nibbled up by dog, thus said product can not provide prolonged chewing time. Moreover, because the chicken jerky is present in rather small ratio in the product and most of the jerky is covered by the rawhide, further because the steps of softening by sock and oven drying in the process procedure causes deterioration of the original smell and taste, hence said product is relatively far from being perfect.

Accordingly, there still exists the need in this field to provide a new chewing product for domestic carnivorous animals, which is more attractive in the viewpoint of nutrition and delicate flavor and can provide prolonged chewing time.

### SUMMARY OF THE INVENTION

In order to achieve the above-mentioned purpose, the present invention provides a new chewing product for domestic carnivorous animals, which comprises rawhide materials and natural bones, characterized in that, said natural bones are wrapped in said rawhide materials.

In one preferred embodiment, said chewing product presents a bone-shape, roll-stick-shape or twist-shape.

In one preferred embodiment, said rawhide materials cover up the natural bones, are rolled up and knotted in both ends.

In one preferred embodiment, said rawhide materials cover up the natural bones, are rolled up and pressed in a mold into bone-shape.

In one preferred embodiment, said rawhide materials roll up said natural bones therein to form a cylinder shape, said natural bones are exposed out from one or both ends.

In one preferred embodiment, said rawhide materials wind around said natural bones to form a twist shape.

In one preferred embodiment, said rawhide materials are pulverized into powder or particles, and then are coated on the surface of said natural bones by binder.

In one preferred embodiment, said natural bones are partly exposed outside of said rawhide.

In one preferred embodiment, there are openings formed on said rawhide.

In one preferred embodiment, said rawhide materials are selected from cattle skins, hog skins or sheep skins.

In one preferred embodiment, said natural bones are selected from chicken bones, duck bones, goose bones, hog bones, cattle bones or sheep bones.

As well known, dogs have a basic instinct to biting and chewing bones. Delicacy and good smell of the natural bone, which are emitted out from marrow in the bones lure dogs to continuously nibble and bite the bones and make effort trying to take in all the marrow. Therefore, from the viewpoint of the instinct, natural bones are the first choice for dogs. Meanwhile, the hard exteriors of natural bones provides prolonged chewing time for dogs. Additionally, the natural bones contain abundant calcium which plays an important role for dogs' skeleton, teeth and growth. All of these facts have made other analogous products incomparable to the inventive products.

Experiments showed that, when the chewing products solely made from rawhide and the chewing products of the present invention are placed together, almost 100% of dogs chose the product of the present invention. When the chewing product comprising chicken jerky (U.S. Pat. No. 5,673,653) is placed along with the present inventive product, about 80% of dogs chose the product of the present invention.

Regarding the chewing time, the experiments showed that most of dogs have little interest in chewing products solely made from rawhide, and a few dogs discard the products aside after chewing for a few minutes. In the case of the chewing product comprising chicken jerky, after chewing for several tens of minutes, the jerky are nibbled up and the dogs loose their interest and stopped chewing. In contrast, upon obtaining the present inventive product, dogs continuously bit and chew without relaxing or releasing.

### BRIEF DESCRIPTIONS OF DRAWINGS

FIG. 1 shows a chewing product in one embodiment according to the present invention.

FIG. 2 shows the cross-section of the chewing product shown in FIG. 1.

FIG. 3 shows a chewing product with knots in both ends in one embodiment according to the present invention.

FIG. 4 shows a chewing product in another embodiment according the present invention.

### DETAILED DESCRIPTION OF SPECIFIC EMBODIMENTS

The present invention will be described in details in combination with the appended figures as follows.

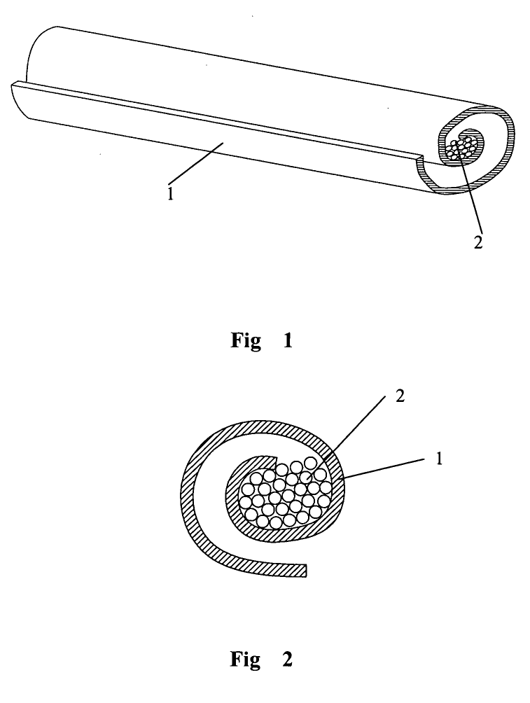

FIG. 1 shows a chewing product for domestic carnivorous animals in one embodiment. As shown in the figure, natural bones material 2 is wrapped up in the rawhide material 1. The cross-section of said product is shown in FIG. 2. It is appreciated that the appended figures are illustrative, which by no means indicate that the natural bone materials wrapped up in the rawhide material or the present chewing products should take the shapes as shown in the figures. According to the definitions used herein, said natural bones are traditional animal bones, which, for example, may be selected from the group consisting of chicken bones, duck bones, goose bones, hog bones, cattle bones and sheep bones, and the like. Said natural bones may come from any parts of the animals, for example, ribs, leg bones, and the like. Chicken bones and hog leg bones (shanks) are preferred. In another embodiment, natural bones also refer to a mixture of various natural bones. There is no specific limitation or requirement to the sources of said natural bones. Dependent on the sources, there may be a little of skin, tendon or meat remaining on the surface of the bones, but the major portion is constituted by bones. Said bones may be in their intact shapes or bone fragments or chips, which are produced by for example breaking process. According to the definition used herein, said rawhide includes those derived from animal source, such as cattle skin, hog skin, sheep skin, and the like. In preferred embodiments, said rawhide is raw cattle skin. When it is wet, the rawhide is soft and can be folded, bent, cut or punched.

The chewing product according to the present invention can be produced by the following process. The rawhide is firstly wetted and softened. Then the above-mentioned natural bones are wrapped up by said wet rawhide to form a roll having the cylinder shape as shown in FIG. 1. The term “wrapping up” used herein has the broadest meanings as understandable by the skilled in the art, namely, the rawhide substantially covers up the natural bones. The term also encompasses in its scope the meanings of “rolling together/up”, “winding up”, “surrounding”, “covering” and the like. The obtained cylinder-shape rolls have natural bone materials filled therein. Subsequently, said rolls are dried, e.g., in an oven, to finally obtain the present inventive products.

Although said product is stiff under ordinary conditions, it becomes soft and produces certain toughness upon being chewed by dog and wetted by saliva and thus it is not broken in short period.

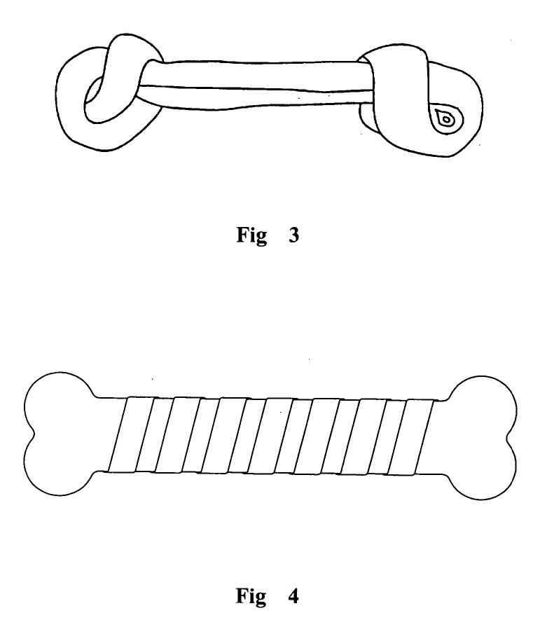

In order to make the chewing product more attractive to dogs, it may be formed into the shapes that the dogs like, such as bone-shape, rolls and twist-shape. The methods used for production are also well known in the art. For example, the above-mentioned rolls can be formed into bone-shape by mold pressing. In addition, as shown in FIG. 3, the rolls can be made to be bone-shape by making knots at one or both ends.

In the present application, said natural bones may be entirely wrapped up in the rawhide materials. For enhancing appealing to dogs, it is preferred to produce the product with minor portions of the natural bones exposed outside the rawhide. In one embodiment, the exposure of the natural bones may be achieved by making openings in the rawhide. Said openings do not allow the natural bones wrapped in the rawhide to drop out. In another embodiment, the rawhide may cover up the entire natural bone and the rawhide used is shorter in length than the bone, such that one or both ends of the bone are exposed outside. In another embodiment, it is also possible to use long and narrow strips of the rawhide to wind up the entire natural bones to make portions of the bones being exposed (cf. for example, FIG. 4).

In the present invention, the term “rawhide” has the meanings comprising not only rawhide sheet member, but also the rawhide materials with smaller volume, such as rawhide fragments, or even the powder or particles of rawhide made by pulverizing the rawhide, which can be coated on surface of the bones by binders such as gelatin, starch, and the like, then pressed in molds to form chewing products having bone-shape or stick-shape.

The present invention will be further illustrated by the following examples.

### EXAMPLE 1

Dry raw cattle skin is wetted by soaking to make it soft. The rawhide is rolled up at one side to wrap chicken bones up therein. The roll is knotted on both ends to form a bone-shape with the chicken bones exposed from both ends, then is dried to obtain the chewing product.

### EXAMPLE 2

Fresh raw cattle skin is processed by washing. The rawhide is rolled at one side to wrap chicken bones up therein. The roll is tied on both ends to form a bone-shape with the chicken bones exposed from both ends. Then, it is dried to obtain the chewing product.

### EXAMPLE 3

Dry raw cattle skin is wetted by soaking to make it soft. The rawhide is rolled up at one side to wrap chicken bones up therein without the chicken bones exposed from both ends. The obtained rolls are then placed in bone-shaped molds for press molding and then is dried in oven to obtain the bone-shaped chewing product.

### EXAMPLE 4

The procedure of Example 3 is repeated to obtain the chewing product, except that openings having size much smaller than the chicken bone therein.

### EXAMPLE 5

By using the entire chicken bone and wet raw cattle skin, which is smaller in length than the chicken bones, the entire chicken bones are wrapped up by the wet raw cattle skin with the chicken bones exposed from both ends, then dried to form the chewing product.

### EXAMPLE 6

Wet raw cattle skin is cut into long narrow strips and is winded up on the entire chicken bones, then dried to form the chewing product in the shape of twist.

### EXAMPLE 7

Raw cattle skin is pulverized into powders or particles, and then coated, with gelatin and starch as binder, onto the surface of chicken bones. Then, it is pressed in molds and dried to form the chewing product.

Although particular examples are described as above, it is obvious to those skilled persons in the art that various alterations and modifications can be made without separating from the spirit and scope of the present invention. Therefore, the appended claims cover up all these modification falling within the scope of the present invention.

1. A chewing product for domestic carnivorous animals, characterized in that, said product comprises rawhide material and natural bone, said natural bone is wrapped up by said rawhide material.

2. The chewing product for domestic carnivorous animals according to claim 1, characterized in that, said chewing product is in the shapes of a bone, a roll or a twist.

3. The chewing product for domestic carnivorous animals according to claim 1, characterized in that, said rawhide material covers up the natural bone and they are rolled up together and knotted on both ends.

4. The chewing product for domestic carnivorous animals according to claim 1, characterized in that, said rawhide material covers up the natural bone and they are rolled up together and pressed in a mold into a bone-shape.

5. The chewing product for domestic carnivorous animals according to claim 1, characterized in that, said rawhide material wraps up the natural bone therein to form a cylinder shape, said natural bone being exposed out from one or both ends of the rolls.

6. The chewing product for domestic carnivorous animals according to claim 1, characterized in that, said rawhide material winds up on surface of the natural bone to form a twist shape.

7. The chewing product for domestic carnivorous animals according to claim 1, characterized in that, said rawhide material is pulverized into powders or particles and coated on surface of the natural bone by a binder.

8. The chewing product for domestic carnivorous animals according to claim 1, characterized in that, portions of said natural bone are exposed out of the rawhide.

9. The chewing product for domestic carnivorous animals according to claim 1, characterized in that, there are openings in the rawhide material.

10. The chewing product for domestic carnivorous animals according to claim 1, characterized in that, said rawhide material is selected from the group consisting of cattle skin, hog skin, and sheep skin.

11. The chewing product for domestic carnivorous animals according to claim 1, characterized in that, said natural bone is selected from the group consisting of chicken bone, duck bone, goose bone, hog bone, cattle bone and sheep bone.
